(19) United States
(12) Patent Application Publication
(10) Pub. No.: US 2021/0127595 A1
(43) Pub. Date: May 6, 2021

(54) Containment and Transportation System

(71) Applicant: NurserySource International Ltd., Boring, OR (US)

(72) Inventor: Emerson T. Springer, Gresham, OR (US)

(21) Appl. No.: 17/087,529

(22) Filed: Nov. 2, 2020

Related U.S. Application Data
(60) Provisional application No. 62/929,629, filed on Nov. 1, 2019.

(51) Int. Cl. A01G 9/02; A01C 21/00

(52) U.S. Cl. CPC A01G 9/02; A01C 21/00

(57) ABSTRACT

Methods and systems are described herein including a containment system to contain a portion of a plant including a root structure and soil within a rigid wall pot. The containment system may be configured to permit the roots of the plant therein to traverse a wall of the containment system. The containment system may be configured to support the root and/or soil of the plant once removed from the rigid wall pot.

### BACKGROUND

Solid walled pots have been conventionally used to contain and grow plants and trees for use in replanting on location. As a plant grows within such a solid walled pot, the roots extend away from the plant and abut the solid wall of the pot. Once the plant roots contact the wall, they have nowhere to go except circumferentially around the edge of the pot. The plant then creates a circling root structure that eventually strangles the plant. When the plant is then transplanted into an uncontained environment, the roots continued their circular growth pattern. The roots do not grow outward to provide stability for the plant. The lifespan of the plant is thereafter limited.

To overcome the difficulty in containing a plant and reduce the circulation of the root structure, holes may be incorporated into the solid wall structure of the pot to permit roots to traverse the pot wall. FIG. 1 illustrates an exemplary configuration of a pot having lateral side apertures to permit roots of a plant to extend outward beyond the pot solid wall. Once the roots traverse the pot wall, the roots are air pruned that keeps the roots from continuing to grow.

Using pots having a traversable wall still includes many limitations that are part of solid wall pots that occur after the use of the pot. For example, in preparing a plant for replanting, the plant is removed from the pot before being positioned in the ground. To retain the soil and roots before being replanted, a bag or other intermediate holder can be used before the plant is positioned in the ground. Removing the plant from the pot, repositioning or attaching the intermediary holder, and then removing the intermediary holder is very time and labor intensive. The addition and removal of the intermediary holder adds substantial cost to the method of replanting.

Other forms of growing nursery stock are also used. For example, stock may be grown in the ground prior to transplanting such nursery stock at another location. U.S. Pat. Nos. 4,574,522; 4,888914; 5,103,588; 5,167,092; and US Patent Publication No. 2009/0107041 describe porous fabric containers for use to retain roots within a confined space before replanting. The intention is to confine the root structure within the fabric container so that the roots are not damages when the plant is removed from the ground for transportation. The purpose of these bags is to prune the roots by choking or girdling the root as it passes the fabric. The roots form a callous at the bag interior.

### SUMMARY

Exemplary embodiments disclosed herein include methods and systems for intermediate retention of a plant and for transplanting a plant from a rigid pot to the ground or another pot or location.

### DRAWINGS

FIG. 1 illustrates an exemplary traversable wall pot conventionally used to overcome root spiralling.

FIG. 2 illustrates an exemplary flexible liner within a traversable wall pot according to embodiments described here.

FIG. 3 illustrates an exemplary flexible liner within a traversable wall pot according to embodiments described here.

FIGS. 4A-4B illustrate exemplary flexible liners according to embodiments described herein.

FIG. 5 illustrates an exemplary cross sectional view of a flexible liner within a traversable wall pot according to embodiments described herein.

FIG. 6 illustrates an exemplary method according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments described herein include a containment system and method for temporary retention of the roots and soil associated with the plant once it is removed from a rigid pot. In an exemplary embodiment, the containment system includes a structure for positioning in the plant pot that remains with the root and soil when the plant is removed from the pot. The containment system may be configured to permit the plant's removal from the pot before the plant is repositioned in the ground or another location.

In an exemplary embodiment, the containment system is configured to fit within the rigid wall pot. The containment system may be configured to approximate the shape and size of a rigid walled pot to be positioned within the pot during use. The containment system may be semi-rigid or shaped to correspond to a rigid wall pot. The containment system may come in different sizes, shapes, and configurations to conform to the rigid pot.

In an exemplary embodiment, the containment system may be flexible to fit within a rigid wall pot and accommodate variability of rigid pot size and configurations. In an exemplary embodiment, the containment system may be flexible to conform to an interior of a rigid pot size and deform depending on the shape, size, and configuration of the rigid wall pot that permits variability between the rigid pot size, shape, and structure.

In an exemplary embodiment, the containment system includes a structure for positioning in the rigid pot that can facilitate the continued growth of the roots similar to the traversable wall. The containment system may include a porous structure. The porous structure creates a traversable wall containment system that allows the roots to traverse from an interior of the containment system to an exterior side of the containment system. As used herein, porous is understood to include spacing through the containment system wall. The spacing may be created through, for example, fabric weaving, apertures positioned within the structure, openings created into the structure, or other spacing.

In an exemplary embodiment, the containment system includes a retention structure for retaining the containment system with the plant after the plant is removed from the rigid pot. The containment system includes an extension at the top of the containment system that may be enclosed and retain the roots and soil within an enclosure of the containment system. The retention structure may be used to close or cover the opening and fully enclose the roots and soil and contact and/or attach directly to a stem or trunk of the plant. The retention structure may include flaps, straps, handles, or other extension that may be attached, tied, retained, wrapped or otherwise attached to the stem or trunk of the plant.

In an exemplary embodiment, the containment system may include a removal structure to facilitate removal of the containment system from the rigid pot. The removal structure may include a structure to facilitate the pulling or separation of the containment system from the rigid pot. For example, the containment system may include handles. In an exemplary embodiment, the removal structure may include a low friction surface or substance.

The containment system may include a removal system that is configured to permit removal from the plant before the plant is repositioned in the ground or another location. The removal system may include perforations or other degradation of the containment system to permit the containment system to be opened or separated. For example, the containment system may include one or more perforation lines to permit the containment system to be separated and facilitate the removal of the containment system from the plant. The removal system may include other features that weaken the containment system wall at a designated location to permit the containment system to be removed. For example, material may be removed, a thickness or dimension of the material may be reduced, porosity may be increased, density of the material may be reduced, or other combination thereof. The removal system may include sewing, buttons, hook and loop, or combinations thereof.

The containment system may be maintained on the plant when repositioned or replanted. In this case, the containment system may degrade or be naturally removed during continued use or growth of the roots from the plant once replanted to a new location. The containment system may be degradable over a desired period of time. Because the containment system is positioned within a rigid pot during the growth of the plant, the integrity of the containment system should be maintained during the growth period and in the intermediate time before being repositioned or planted. The containment system may be configured to maintain its integrity over a normal growth duration before being planted. For example, the duration of degradation may last at least a year, a few years, or many years before degradation critically effects the integrity of the containment system. In an exemplary embodiment, the containment system may comprise a degradable material or substance. The period of degradation may be set to occur over a desired duration. The containment system may include two or more degradable materials having different degradation periods. For example, a first degradable material may be a coating or covering over a second degradable material. The first degradable material may protect the second degradable material that maintains its integrity for a desired period of time. The desired period of time may be related to the duration of a desired growth period for the plant before a conventional replant period. The second degradable material may comprise a degradable material that degrades on a second desired period of time. The second degradable material of the second desired period of time may be less than a time for the first degradable material. The degradation from the first material to the second material may be different. In an exemplary embodiment, the degradation of the first material may be based on time, while the second material may degrade based on contact with a catalyst. For example, the second material may be soluble in water. Once the first material degrades, the second material may come in contact with the catalyst for degrading the second material. In an exemplary embodiment the integrity of the containment system may be maintained for more than three years. In an exemplary embodiment, the containment system maintains integrity for five to fifteen years.

In an exemplary embodiment, the containment system may include nutrients, fertilizer, plant food, or other substance to assist in the growing of the plant.

In an exemplary embodiment, the containment system comprises a mesh. The containment system may be fabric. The containment system may include score lines, perforations, fabric density, weave patterns or other removal system to facilitate removal of the containment system from a plant. In an exemplary embodiment, the containment system may include nutrients, fertilizer, or other substance to assist in the growing of the plant. Exemplary embodiments include non-woven or woven fabrics. Exemplary embodiments may include mesh. Exemplary embodiments may include a material or structure to reduce or prevent the absorption of water, minimizing build up of nutrient salts, algae, bacteria, or other thing harmful to the plant.

In an exemplary embodiment, the containment system may be partially rigid to define a shape for at least a temporary amount of time when not contained within another structure. For example, the containment system may comprise a hybrid solid container and bag combination that has sufficient structure and integrity to meet both requirements of the separate components. It may therefore by sufficient rigid to retain an approximate shape during independent use, and sufficiently flexible to fit and conform to another structure.

Exemplary embodiments includes methods for using a containment system according to embodiments described herein as a transitory container. The method may include positioning a containment system according to embodiments described herein within a rigid pot. The containment system may be positioned between the rigid pot and soil and a plant for growth within the rigid pot. The method may include removing the plant and soil from the rigid pot. During removal of the plant from the rigid pot, the method may include separating the containment system from the rigid pot and retaining the containment system with the plant. The containment system may be secured to the plant. For example, the containment system may be connected to the plant after the growth of the plant at the time the plant is removed from the rigid pot. The time proximity of removing the plant from the rigid pot may be proximate in time. The containment system may be attached before, during, or after the plant is removed from the containment system. The containment system may be tied or connected directly to a stem or trunk of the plant. Before attachment of the containment system to the plant, the containment system may be configured to permit an opening for the unfettered growth of the plant for a duration while the plant is in the rigid pot. The method may include removing the containment system from the plant after the plant has been removed from the rigid pot. The containment system may be configured to retain the roots and soil of the plant for a duration after the plant is removed from the rigid pot. The method may include positioning the plant in the ground or another location. The containment system may be removed before replanting the plant. The containment system may be removed after the replanting the plant.

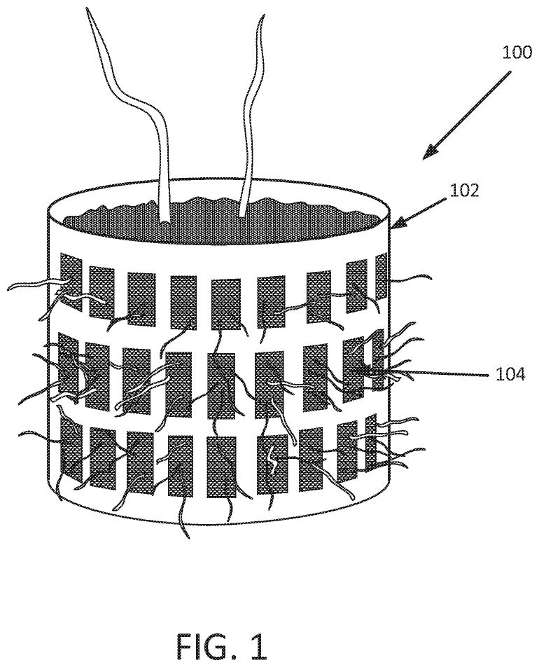

FIG. 1 illustrates an exemplary aeration rigid wall pot. The planting system100 may include a rigid wall 102 pot. The rigid wall 102 may circumscribe the plant base including containing the soil and roots of a plant therein. The rigid wall 102 may include an enclosed bottom side and an open top side. As illustrated, the rigid wall may circumscribe the planting system, thereby defining lateral sides to the system. The lateral sides may comprise any desired shape. For example, the rigid wall 102, may be cylindrical. The cross section of the cylindrical structure may be rectangular, square, circular, ovoid, of other shape. The rigid wall 102 may also be tapered. For example, the top of the rigid wall proximate the open end may define a diameter, area, or cross sectional distance that may be larger or smaller than a corresponding dimension of the bottom of the rigid wall proximate the closed end. The taper may be a step wise taper in which the circumference, diameter, cross-sectional dimension, area, or other dimension is constant for a first portion corresponding to a first height of the rigid wall traversing from top to bottom (or visa versa), and then may change to another circumference, diameter, cross-sectional dimensions, area, or other dimension for second portion corresponding to a second height of the rigid wall. Any number of step-wise transition and/or continuous transitions may be used in any combination to create any number of sections and remain within the scope of the present invention.

The planting system 100 may include apertures 104 through the rigid wall 102, including the lateral sides and/or closed bottom. The apertures 104 are configured to permit the roots of the plant to pass there through unimpeded. The roots are therefore permitted to grow outward and not circumscribe or wrap within the interior surface of the rigid wall. Once exposed to the air after the root has traversed the rigid wall 102, the root may naturally stop growing outward. The aeration rigid wall pot therefore may provide natural pruning of the root system while minimizing the circulation of the root system.

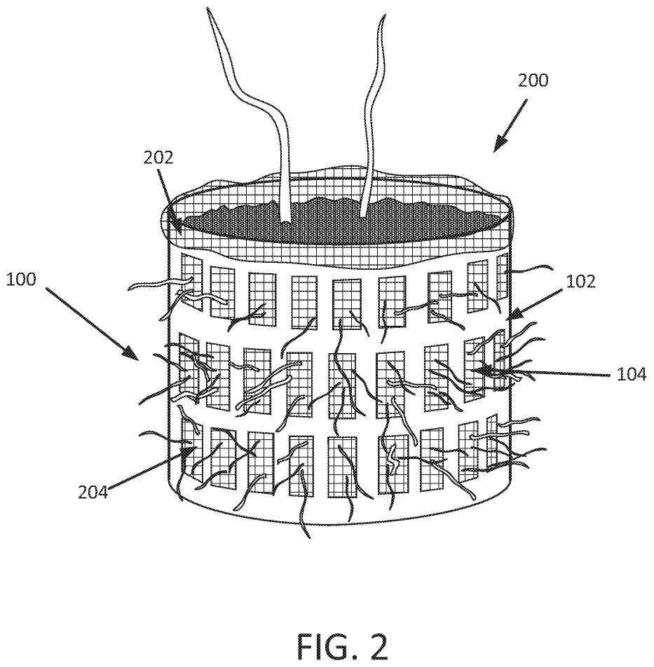

FIG. 2 illustrates an exemplary embodiments described herein including a containment system 200 for retention of the roots and soil associated with the plant once it is removed from a rigid pot 100. In an exemplary embodiment, the containment system 200 includes a structure for positioning in the plant pot that remains with the root and soil when the plant is removed from the pot. The containment system may be configured to permit the plant's removal from the pot before the plant is repositioned in the ground or another location.

As illustrated in FIG. 2, in an exemplary embodiment, the containment system 200 includes a structure 202 for positioning in the rigid pot 100 that can facilitate the continued growth of the roots similar to the traversable wall. The containment system may include a porous structure 204. The porous structure 204 creates a traversable wall containment system that allows the roots to traverse from an interior of the containment system to an exterior side of the containment system. As used herein, porous is understood to include spacing through the containment system wall. The spacing may be created through, for example, fabric positioning and/or weaving, apertures positioned within the structure, openings created into the structure, or other spacing in the material itself or added to the structure to create the requisite passage through the containment system wall.

In an exemplary embodiment, the containment system 200 comprises a flexible material defining a porous structure. In an exemplary embodiment, the porous structure is configured to be sufficiently strong to retain a substantial majority of the soil with the roots after being removed from the rigid pot. The porous structure is also configured to reduce and/or minimize the impedance of the roots from traversing to an exterior side of the containment structure and through the apertures 104 of the rigid wall 102 of the pot 100. Similar to the rigid wall aeration pot, some roots may encounter the material structure of the rigid pot and/or containment structure. However, the intent is to permit the roots to pass there through without hindrance. Unlike prior art system in which the root system is intentionally restricted to prevent and/or reduce the roots from passing through the flexible covering, the instant disclosure is configured to be used in combination with an aeration pot and permit passage of the root system through the containment system and through the apertures of the aeration pot. In an exemplary embodiment, the containment structure comprises a non-woven polypropylene fabric.

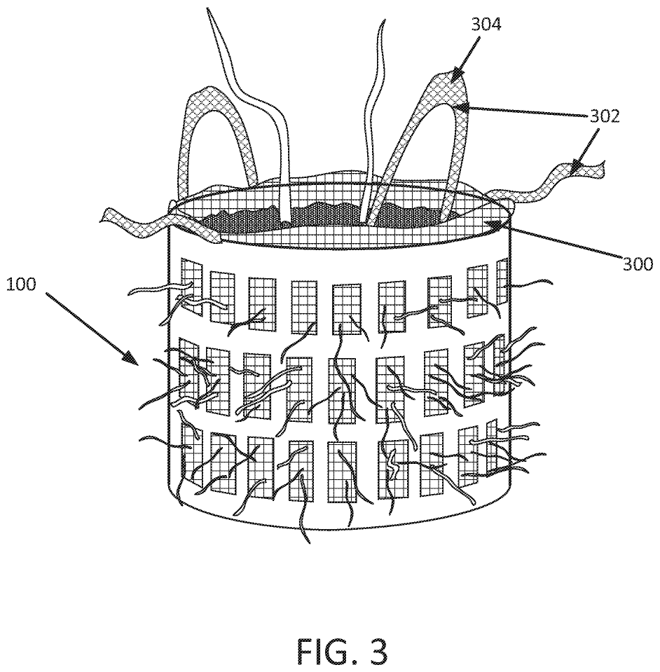

As seen in FIG. 3, the containment system 300 may include a retention structure 302 for retaining the containment system with the plant after the plant is removed from the rigid pot. The containment system 300 includes an extension at the top of the containment system that may be used to enclose and retain the roots and soil within an enclosure of the containment system. The retention structure may be used to close or cover the opening and fully enclose the roots and soil and contact and/or attach directly to a stem or trunk of the plant. The retention structure may include flaps, straps, handles, or other extension that may be attached, tied, retained, wrapped or otherwise attached to the stem or trunk of the plant.

Also as seen in FIG. 3, the containment system 300 may include a removal structure 304 to facilitate removal of the containment system from the rigid pot. The removal structure may include a structure to facilitate the pulling or separation of the containment system from the rigid pot 100. For example, the containment system may include handles. In an exemplary embodiment, the removal structure may include a low friction surface or substance. In an exemplary embodiment, the removal structure may be the same feature or element as the retention structure.

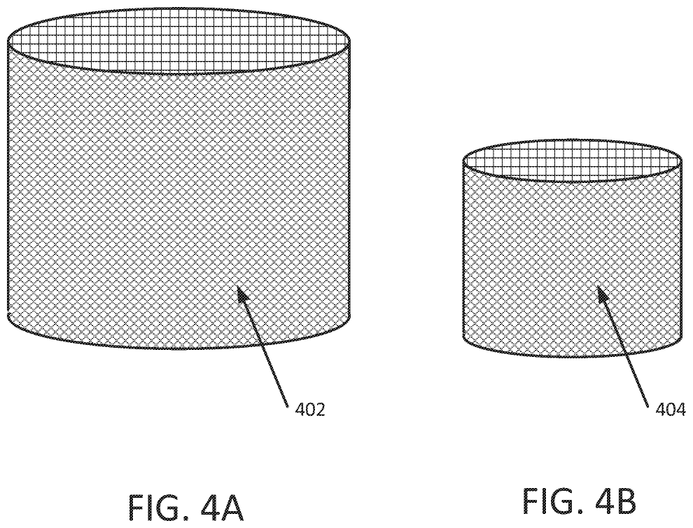

FIGS. 4A and FIG. 4B illustrate exemplary containment systems 402, 404. The containment system may be flexible in that it can deform upon application of an applied force without breaking. In an exemplary embodiment, the containment system is configured to fit within the rigid wall pot. The containment system may therefore be configured such that an exterior surface of the containment system 402, 404 approximates the shape and size of an interior surface of a specific rigid walled pot. Exemplary embodiments may therefore include different containment systems 402, 404 that are configured to be positioned within a specific pot of corresponding size and/or shape. The containment system may be semi-rigid or shaped to correspond to a rigid wall pot. The containment system may come in different sizes, shapes, and configurations to conform to the rigid pot. In an exemplary embodiment, the corresponding size between a containment system and the rigid wall pot is to minimize the overlap or distortion of the wall of the containment system to reduce the impedance of the roots through the containment system.

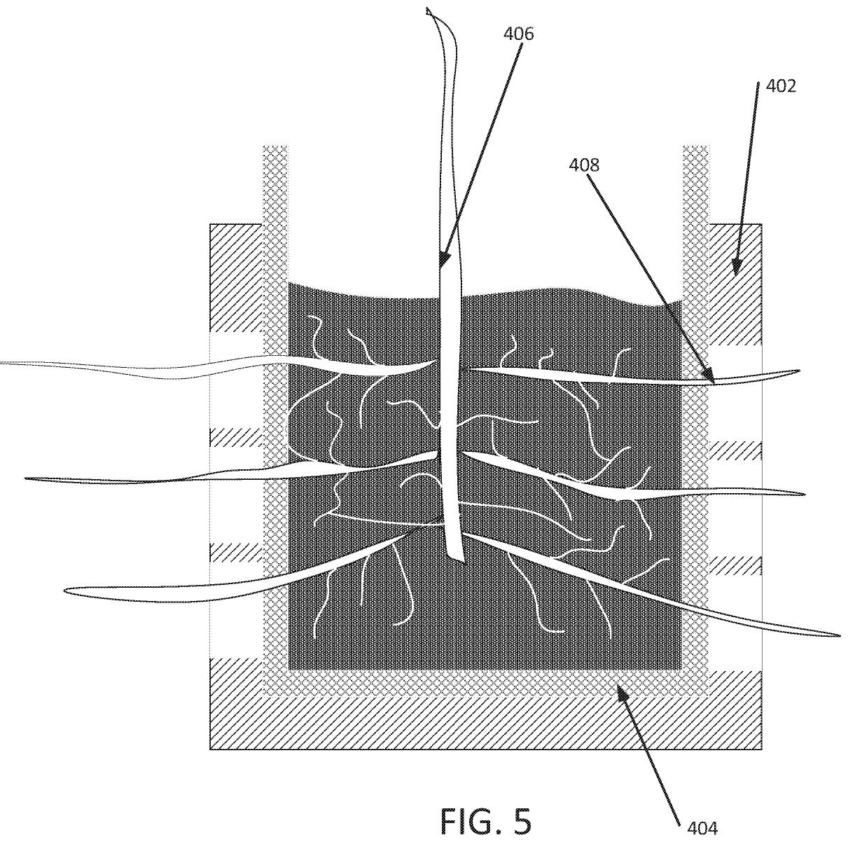

FIG. 5 illustrates an exemplary cross section of a containment system 404 within a corresponding rigid wall pot 402 in which a plant 406 has roots 408 extending through and traversing the containment system 404 and rigid wall pot 402. As illustrated, the roots may traverse the containment system and rigid wall pot with minimal interference. The roots therefore grow out of the pot within or with minimized deformation to the root structure. The reduction in the root deformation is in the circulation of the roots within an interior surface of the pot structure as well as in the production of nodes at the root ends on the interior surface of the containment structure. Although some deformation of the roots may occur, the instant invention may minimize the deformation of the root structure that is the purpose of many other containment systems.

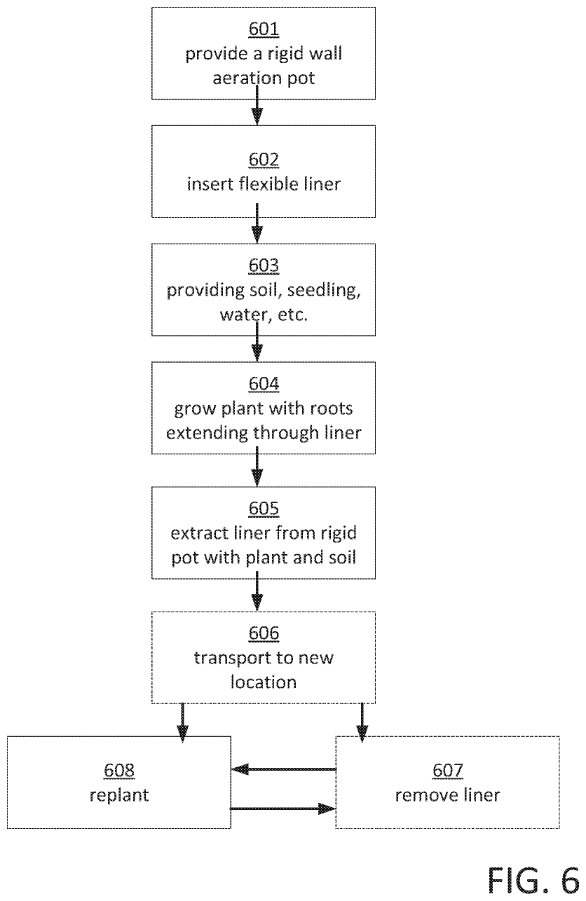

FIG. 6 illustrates an exemplary method according to embodiments described herein. Exemplary embodiments include the use of a flexible liner according to embodiments of the containment system described herein within a rigid wall pot. The method includes the use of the flexible liner within an aeration rigid wall pot in which the pot has apertures for permitting the roots to extend there through as the plant grows and develops. Exemplary embodiments includes methods for using a containment system according to embodiments described herein as a transitory container.

The method may start with step 601 by providing a rigid wall pot according to embodiments described herein. The rigid wall pot may be an aeration pot having a rigid wall and apertures extending there through. The apertures of the aeration pot may be configured to permit the roots of a plant growing therein to extend through the wall of the aeration pot.

The method may include, at step 602, positioning a containment system according to embodiments described herein within the rigid pot. In an exemplary embodiment, the containment system may define a flexible liner. The flexible liner may approximate and interior size and/or shape of the rigid pot. The flexible liner may be semi-rigid to maintain an approximate shape when not deformed by an exterior force. The approximate shape maintained by the semi-rigid flexible liner may approximate an interior size and/or shape of the rigid pot. The flexible liner may be positioned within the rigid pot such that there is substantially no overlapping portion of the flexible liner on itself to reduce or minimize the impedance of the flexible liner to the root system of the plant.

The method may include, at step 603 adding soil, seeds, and/or seedling into the pot. The containment system may therefore be positioned between the rigid pot and soil and a plant for growth within the rigid pot. The flexible liner may be positioned within the rigid pot such that there is substantially no overlapping portion of the flexible liner on itself to reduce or minimize the impedance of the flexible liner to the root system of the plant.

The method, at step 604, the plant is permitted to grow. As the plant grows, the root traverse through the flexible liner and out of the rigid pot. Once exposed to the air, the root may discontinue its growth laterally outward. The method may include any other care required to the plant to assist in its growth and development. For example, the plant may be watered or may be provided nutrients, light, or materials and/or environment to assist in growth. In an exemplary embodiment, the rigid pot and inserted flexible liner are retained above ground during growth of the plant. The flexible liner and rigid pot system may therefore provide or permit 360 degree aeration and/or drainage from the system during plant development. The flexible liner and rigid pot system may include apertures and/or a porous structure on the lateral sides, the bottom, top, or any combination of the flexible liner and/or rigid pot. The system may include permitting the 360 degree aeration and drainage from the flexible liner and aeration pot. The method may include growing the roots out of the pot with minimized or reduced deformation to the root structure. The reduction in the root deformation is in the circulation of the roots within an interior surface of the pot structure as well as in the production of nodes at the root ends on the interior surface of the containment structure. Although some deformation of the roots may occur, the instant invention may minimize the deformation of the root structure that is the purpose of many other containment systems.

The method, at step 605, may include removing the plant and soil from the rigid pot. During removal of the plant from the rigid pot, the method may include separating the containment system from the rigid pot and retaining the containment system with the plant. The containment system may be secured to the plant. For example, the containment system may be connected to the plant after the growth of the plant at the time the plant is removed from the rigid pot. The time proximity of removing the plant from the rigid pot may be proximate in time. The containment system may be attached before, during, or after the plant is removed from the containment system. The containment system may be tied or connected directly to a stem or trunk of the plant. Before attachment of the containment system to the plant, the containment system may be configured to permit an opening for the unfettered growth of the plant for a duration while the plant is in the rigid pot. In an exemplary embodiment, the roots of the plant are permitted to grow through the flexible liner. Upon removal of the plant from the rigid pot, the roots may be the retention feature retaining the flexible liner to the roots and the plant and enclosing the soil therein.

The method, at step 606 may include transporting the plant with the containment structure to a new location. The new location may be any distance from the rigid pot. In an exemplary embodiment, the transportation may include physical transportation through boat, car, train, or other mechanical method. During transport, the flexible line may be configured to retain the root structure and soil thereto. The containment system may therefore be configured to retain the roots and soil of the plant for a duration after the plant is removed from the rigid pot. The transportation of the plant to another location is option. The plant may be directly replanted at the same location. This may be necessary, for example, if the rigid pot was broken or otherwise unusable before the plant has matured by a desired amount.

The method, at step 607, may include removing the containment system from the plant after the plant has been removed from the rigid pot. The removal may be through the use of a removal structure according to embodiments described herein. In an exemplary embodiment, the removal may be through cutting and/or tearing of the flexible liner and tearing and/or pulling the liner away from the roots and/or soil.

The method, at step 608, may include positioning the plant in the ground or another location. The containment system may be removed before replanting the plant. The containment system may be removed after the replanting the plant. In an exemplary embodiment, the containment system is not removed from the plant before planting. Thus, as illustrated, the liner may be removed at step 607 before or after replanting at step 608 or may not be removed at all.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A containment structure, comprising a flexible structure configured to conform to an interior of a rigid wall structure, the flexible structure being porous to permit roots to traverse there through.

2. The containment structure of claim 1, wherein the flexible structure is porous with sufficient porosity to reduce root deformation during the growth of a plant within the flexible structure.

3. The containment structure of claim 1, wherein a wall of the flexible structure comprises a plurality of apertures that allows roots of a plant to traverse the wall.

4. The containment structure of claim 1, further comprising a retention structure.

5. The containment structure of claim 4, wherein the retention structure comprises a plurality of extensions from an opening of the containment structure.

6. The containment structure of claim 5, further comprising handles.

7. The containment structure of claim 1, further comprising a removal structure to facilitate the removal of the containment system.

8. The containment structure of claim 1, further comprising a removal system.

9. The containment structure of claim 8, wherein the removal system comprises perforations in a wall of the containment structure.

10. The containment structure of claim 1, wherein the containment structure comprises a degradable material.

11. A method, comprising:
positioning a containment system within a rigid pot, wherein the containment system is separable from the rigid pot;
growing a plant from soil contained within the containment system positioned within the rigid pot, wherein roots from a plant grown in the containment system extend through the containment system and the rigid pot to extend on an exterior side of the rigid pot;
removing the plant, soil, and containment system from the rigid pot;
containing the soil around roots of the plant with the containment system after removal from the rigid pot.

12. The method of claim 11, further comprising positioning within the containment system soil and roots of a plant, such that the containment system is between the soil and the rigid pot.

13. The method of claim 11, wherein removing the plant, soil, and containment system from the rigid pot includes separating the containment system from the rigid pot.

14. The method of claim 13, wherein during separation, the containment system is in contact with the soil.

15. The method of claim 11, further comprising securing the containment system to the plant before removing the plant, soil, and containment system from the rigid pot.

16. The method of claim 15, wherein the attachment of the containment system to the plant is by tying the containment system to a trunk of the plant.

17. The method of claim 11, further comprising containing the plant and soil within the containment system independent of any rigid pot for a duration.

18. The method of claim 11, further comprising removing the containment system from the plant.

19. The method of claim 11, further comprising planting the plant within a ground.

20. The method of claim 19, wherein the containment system is removed before planting.

21. The method of claim 19, wherein the containment system is removed after planting.

22. The method of claim 11, further comprising growing roots of the plant through a wall of the containment system.

23. The method of claim 22, wherein growing roots is while the containment system is within the rigid pot.
